(19) United States
(12) Patent Application Publication
(10) Pub. No.: US 2025/0095901 A1
(43) Pub. Date: Mar. 20, 2025

(54) INDUCTOR ASSEMBLY

(71) Applicant: Cyntec Co., Ltd., Hsinchu (TW)

(72) Inventors: Chia-Hui Lee, Hsinchu (TW); Chi-Shiuan Shie, Hsinchu (TW); Chih-Jung Chen, Hsinchu (TW)

(21) Appl. No.: 18/427,615

(22) Filed: Jan. 30, 2024

(30) Foreign Application Priority Data
Sep. 14, 2023 (CN) 202322501580.X

(51) Int. Cl. H01F 27/26

(52) U.S. Cl. CPC H01F 27/263

(57) ABSTRACT

An inductor assembly includes a first magnetic core, a second magnetic core, a winding and a bonding material layer. The second magnetic core includes a channel. The winding is disposed within the channel. The bonding material layer is disposed between the first magnetic core and the second magnetic core and includes a first bonding material and a second bonding material. A magnetic permeability of the first bonding material is greater than a magnetic permeability of the second bonding material. The first bonding material and the second bonding material are disposed on the second magnetic core. A surface of the first bonding material faced to the first magnetic core and a surface of the second bonding material faced to the first magnetic core are coplanar with each other.

### CROSS-REFERENCE TO RELATED APPLICATION

This application claims priority to China Patent Application No. 202322501580.X filed on Sep. 14, 2023, the entire content of which is incorporated herein by reference for all purposes.

### FIELD OF THE INVENTION

The present disclosure relates to an inductor assembly, and more particularly to an inductor assembly having a bonding material.

### BACKGROUND OF THE INVENTION

High-power inductor assembly is applied to a buck converter of an electronic device, for example, a desktop computer or a notebook. The inductor assembly includes a magnetic element and a winding. The inductor assembly has two kinds of inductance values according to the structure design and the saturation characteristic of the magnetic element. FIG. 1 is a schematic waveform diagram illustrating inductance value and DC bias current of a conventional inductor assembly. As shown in FIG. 1, the inductor assembly has a high inductance value when the DC bias current is low. For example, the inductance value of the inductor assembly is 240 nH when the DC bias current is between 0 to 10 A. The inductor assembly has a low inductance value when the DC bias current is high. For example, the inductance value of the inductor assembly is 120 nH when the DC bias current is between 20 A to 80 A. Namely, the inductor assembly is a two-stage inductor assembly. The two-stage inductor assembly has advantages of enhanced inductance value, reduced current ripple and reduced loss when the system is under light load so as to improve efficiency of the system utilizing the buck converter.

The inductor assembly has two kinds of inductance values according to the gap between the upper magnetic core and the lower magnetic core of the magnetic element. However, the gap of the magnetic element results in reduced inductance value in the high-inductance region and wider DC bias current interval corresponding to a transition region between the high-inductance region and the low-inductance region. For example, the interval of the DC bias current corresponding to the transition region of FIG. 1 is between 10 A to 20 A. Consequently, the wider DC bias current interval leads to decrease the response speed when the system is under heavy load.

Therefore, there is a need of providing an inductor assembly to obviate the drawbacks encountered from the prior arts.

### SUMMARY OF THE INVENTION

The present disclosure provides an inductor assembly. The inductor assembly includes a bonding material layer disposed between the first magnetic core and the second magnetic core and including a first bonding material and a second bonding material. Namely, the inductor assembly of the present disclosure utilizes the first bonding material and the second bonding material to fill the gap between the first magnetic core and the second magnetic core so as to increase the inductance value of the inductor assembly ranged in the high-inductance region. Moreover, the magnetic permeability of the first bonding material of the inductor assembly of the present disclosure is greater than the magnetic permeability of the second bonding material, or the thickness of the first bonding material is less than the thickness of the second bonding material. The first bonding material with enhanced magnetic permeability (or reduced thickness) can withstand a lower saturation current so that the magnetic permeability of the inductor assembly is decreased rapidly. Consequently, the interval of the DC bias current corresponding to the transition region of the inductor assembly is reduced, and the response speed of the system utilizing the inductor assembly is enhanced when the system is under heavy load.

In accordance with an aspect of the present disclosure, there is provided an inductor assembly. The inductor assembly includes a first magnetic core, a second magnetic core, a winding and a bonding material layer. The second magnetic core includes a channel. The winding is disposed within the channel. The bonding material layer is disposed between the first magnetic core and the second magnetic core and includes a first bonding material and a second bonding material. A magnetic permeability of the first bonding material is greater than a magnetic permeability of the second bonding material. The first bonding material and the second bonding material are disposed on the second magnetic core. A surface of the first bonding material faced to the first magnetic core and a surface of the second bonding material faced to the first magnetic core are coplanar with each other.

In accordance with another aspect of the present disclosure, there is provided an inductor assembly. The inductor assembly includes a first magnetic core, a second magnetic core, a winding and a bonding material layer. The bonding material layer is disposed between the first magnetic core and the second magnetic core and includes a first bonding material and a second bonding material. A thickness of the first bonding material is less than a thickness of the second bonding material. A surface of the first bonding material faced to the first magnetic core and a surface of the second bonding material faced to the first magnetic core are coplanar with each other.

In accordance with another aspect of the present disclosure, there is provided an inductor assembly. The inductor assembly includes a first magnetic core, a second magnetic core, a winding, a first bonding material and a second bonding material. The winding is disposed between the first magnetic core and the second magnetic core. A lower surface of the first bonding material is in contact with the second magnetic core. A lower surface of the second bonding material is in contact with an upper surface of the first bonding material and the second magnetic core. An upper surface of the second bonding material is in contact with the first magnetic core.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic waveform diagram illustrating inductance value and DC bias current of a conventional inductor assembly;

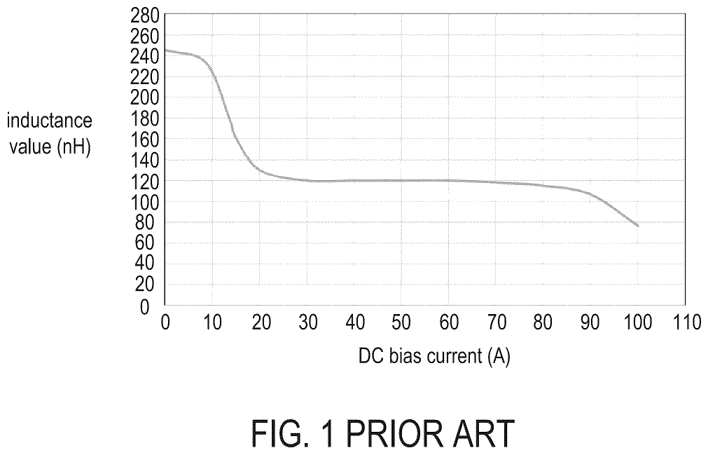

FIG. 2A is a schematic view illustrating an inductor assembly according to a first embodiment of the present disclosure;

FIG. 2B is a schematic exploded view illustrating the inductor assembly of FIG. 2A;

FIG. 2C is a schematic exploded lateral view illustrating the inductor assembly of FIG. 2A;

FIG. 3 is a schematic waveform diagram illustrating inductance value and DC bias current of the inductor assembly of the first embodiment of the present disclosure and the conventional inductor assembly;

FIG. 4A is a schematic view illustrating an inductor assembly according to a second embodiment of the present disclosure;

FIG. 4B is a schematic exploded view illustrating the inductor assembly of FIG. 4A;

FIG. 4C is a schematic exploded lateral view illustrating the inductor assembly of FIG. 4A;

FIG. 5 is a schematic waveform diagram illustrating inductance value and DC bias current of the inductor assembly of the second embodiment of the present disclosure and the conventional inductor assembly;

FIG. 6 is a schematic exploded view illustrating an inductor assembly according to a third embodiment of the present disclosure;

FIG. 7A is a schematic exploded view illustrating an inductor assembly according to a fourth embodiment of the present disclosure;

FIG. 7B is a schematic exploded lateral view illustrating the inductor assembly of FIG. 7A;

FIG. 8A is a schematic exploded view illustrating an inductor assembly according to a fifth embodiment of the present disclosure;

FIG. 8B is a schematic exploded lateral view illustrating the inductor assembly of FIG. 8A;

FIG. 9 is a detailed schematic exploded view illustrating a first bonding material of the inductor assembly of the present disclosure;

FIG. 10 is a partial schematic exploded view illustrating an inductor assembly according to a sixth embodiment of the present disclosure;

FIG. 11A is a schematic view illustrating a second magnetic core of an inductor assembly according to a seventh embodiment of the present disclosure;

FIG. 11B is a schematic view illustrating a second magnetic core of an inductor assembly according to an eighth embodiment of the present disclosure;

FIG. 11C is a schematic view illustrating a second magnetic core of an inductor assembly according to a ninth embodiment of the present disclosure;

FIG. 11D is a schematic view illustrating a second magnetic core of an inductor assembly according to a tenth embodiment of the present disclosure;

FIG. 12 is a partial schematic exploded view illustrating an inductor assembly according to an eleventh embodiment of the present disclosure; and

FIG. 13 is a schematic waveform diagram illustrating inductance value and DC bias current of the inductor assembly of the first embodiment, the sixth embodiment and the eleventh embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

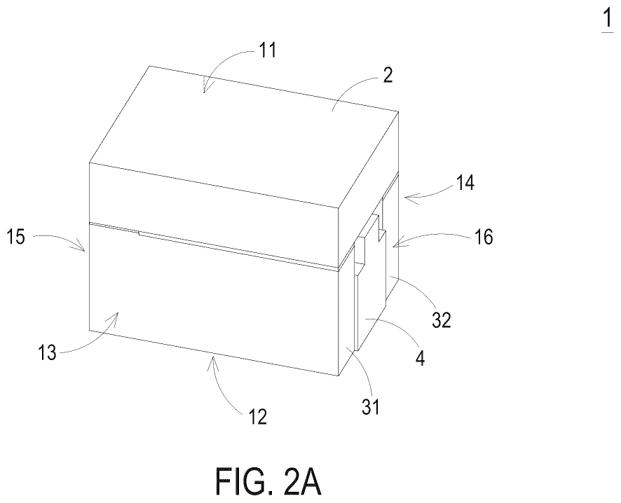

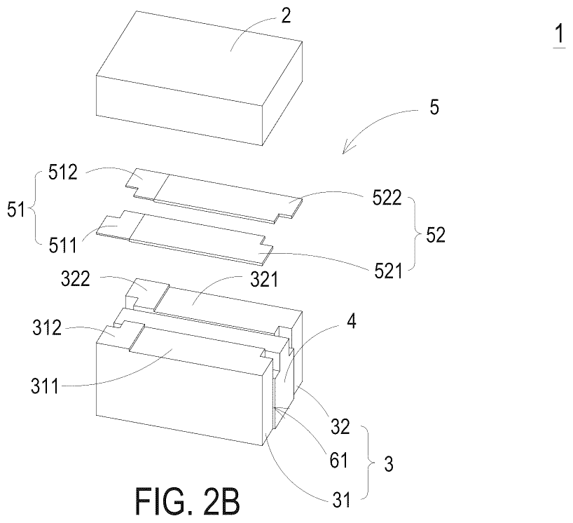

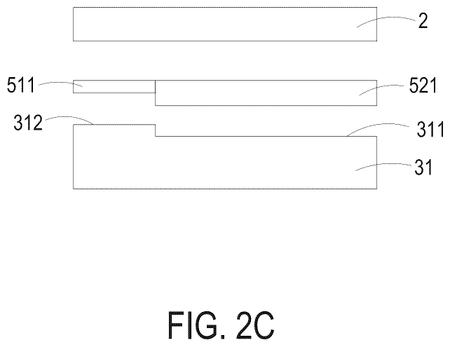

FIG. 2A is a schematic view illustrating an inductor assembly according to a first embodiment of the present disclosure. FIG. 2B is a schematic exploded view illustrating the inductor assembly of FIG. 2A. FIG. 2C is a schematic exploded lateral view illustrating the inductor assembly of FIG. 2A. As shown in FIGS. 2A and 2B, the inductor assembly 1 includes a first surface 11, a second surface 12, a third surface 13, a fourth surface 14, a fifth surface 15, a sixth surface 16, a first magnetic core 2, a second magnetic core 3, a winding 4 and a bonding material layer 5. The first surface 11 and the second surface 12 of the inductor assembly 1 are opposite to each other. The third surface 13 and the fourth surface 14 of the inductor assembly 1 are opposite to each other and located between the first surface 11 and the second surface 12. The fifth surface 15 and the sixth surface 16 are opposite to each other, located between the first surface 11 and the second surface 12, and located between the third surface 13 and the fourth surface 14.

The upper surface of the first magnetic core 2 is served as the first surface 11 of the inductor assembly 1. The second magnetic core 3 and the first magnetic core 2 are stacked to each other. The second magnetic core 3 includes a first sub magnetic core 31, a second sub magnetic core 32 and a first channel 61. The lateral wall of the first sub magnetic core 31 of the second magnetic core 3 and the first lateral wall of the first magnetic core 2 are served as the third surface 13 of the inductor assembly 1 collaboratively. The lateral wall of the second sub magnetic core 32 of the second magnetic core 3 and the second lateral wall of the first magnetic core 2 are served as the fourth surface 14 of the inductor assembly 1 collaboratively. The first sub magnetic core 31 and the second sub magnetic core 32 of the second magnetic core 3 are adjacent to the lower surface of the first magnetic core 2. The surface of the first sub magnetic core 31 of the second magnetic core 3 faced to the first magnetic core 2 includes a first platform 311 and a first elevated stage 312. The first platform 311 and the first elevated stage 312 are arranged in sequence. The first elevated stage 312 is closer to the first magnetic core 2 than the first platform 311, as shown in FIG. 2C. The surface of the second sub magnetic core 32 of the second magnetic core 3 faced to the first magnetic core 2 includes a second platform 321 and a second elevated stage 322. The second platform 321 and the second elevated stage 322 are arranged in sequence. The second elevated stage 322 is closer to the first magnetic core 2 than the second platform 321. The first channel 61 is disposed between the first sub magnetic core 31 and the second sub magnetic core 32. The winding 4 is disposed within the first channel 61 of the second magnetic core 3. In this embodiment, the position of the first elevated stage 312 disposed on the first sub magnetic core 31 is corresponding to the position of the second elevated stage 322 disposed on the second sub magnetic core 32, and the first elevated stage 312 and the second elevated stage 322 are separated by the first channel 61. The position of the first platform 311 disposed on the first sub magnetic core 31 is corresponding to the position of the second platform 321 disposed on the second sub magnetic core 32, and the first platform 311 and the second platform 321 are separated by the first channel 61. The first elevated stage 312 is closer to the fifth surface 15 of the inductor assembly 1 than the first platform 311. The first platform 311 is closer to the sixth surface 16 of the inductor assembly 1 than the first elevated stage 312. The second elevated stage 322 is closer to the fifth surface 15 of the inductor assembly 1 than the second platform 321.

The second platform 321 is closer to the sixth surface 16 of the inductor assembly 1 than the second elevated stage 322. Alternatively, in some embodiments, the position of the first elevated stage 312 disposed on the first sub magnetic core 31 is corresponding to the position of the second platform 321 disposed on the second sub magnetic core 32, and the first elevated stage 312 and the second platform 321 are separated by the first channel 61. The position of the first platform 311 disposed on the first sub magnetic core 31 is corresponding to the position of the second elevated stage 322 disposed on the second sub magnetic core 32, and the first platform 311 and the second elevated stage 322 are separated by the first channel 61.

As shown in FIG. 2B, the bonding material layer 5 includes a first bonding material 51 and a second bonding material 52. The first bonding material 51 includes magnetic powder adhesive, such as manganese zinc, nickel zinc, iron nickel molybdenum alloy, iron silicon aluminum alloy, iron nickel alloy or iron powder core. The particle diameter of the magnetic powder adhesive constituting the first bonding material 51 is ranged between 5 um to 60 um. The second bonding material 52 includes general bonding adhesive. The magnetic permeability of the first bonding material 51 is greater than the magnetic permeability of the second bonding material 52. The first bonding material 51 and the second bonding material 52 are arranged side by side in the direction of the first iron core 2 in contact with the second iron core 3. The arrangement of the first bonding material 51 and the second bonding material 52 will be described below.

In this embodiment, the first bonding material 51 includes a first sub bonding material 511 and a second sub bonding material 512. The first sub bonding material 511 is disposed on the surface of the first elevated stage 312 of the first sub magnetic core 31 of the second magnetic core 3, and disposed between the first elevated stage 312 of the first sub magnetic core 31 of the second magnetic core 3 and the first magnetic core 2. The second sub bonding material 512 is disposed on the surface of the second elevated stage 322 of the second sub magnetic core 32 of the second magnetic core 3, and disposed between the second elevated stage 322 of the second sub magnetic core 32 of the second magnetic core 3 and the first magnetic core 2. The second bonding material 52 includes a third sub bonding material 521 and a fourth sub bonding material 522. The third sub bonding material 521 and the first sub bonding material 511 are connected with each other in sequence. The third sub bonding material 521 is disposed on the surface of the first platform 311 of the first sub magnetic core 31 of the second magnetic core 3, and disposed between the first platform 311 of the first sub magnetic core 31 of the second magnetic core 3 and the first magnetic core 2. The fourth sub bonding material 522 and the second sub bonding material 512 are connected with each other in sequence. The fourth sub bonding material 522 is disposed on the surface of the second platform 321 of the second sub magnetic core 32 of the second magnetic core 3, and disposed between the second platform 321 of the second sub magnetic core 32 of the second magnetic core 3 and the first magnetic core 2. In this embodiment, as shown in FIG. 2C, the first elevated stage 312 is closer to the first magnetic core 2 than the first platform 311, so that the height of the first elevated stage 312 is different to the height of the first platform 311. Consequently, the thickness of the third sub bonding material 521 disposed on the surface of the first platform 311 is greater than the thickness of the first sub bonding material 511 disposed on the surface of the first elevated stage 312. Similarly, the second elevated stage 322 is closer to the first magnetic core 2 than the second platform 321. Namely, the height of the second elevated stage 322 is different to the height of the second platform 321. Consequently, the thickness of the fourth sub bonding material 522 disposed on the surface of the second platform 321 is greater than the thickness of the second sub bonding material 512 disposed on the surface of the second elevated stage 322. Namely, the thickness of the first bonding material 51 is less than the thickness of the second bonding material 52. In this embodiment, the upper surface of the first sub bonding material 511 of the first bonding material 51 faced to the first magnetic core 2, the upper surface of the second sub bonding material 512 of the first bonding material 51 faced to the first magnetic core 2, the upper surface of the third sub bonding material 521 of the second bonding material 52 faced to the first magnetic core 2 and the upper surface of the fourth sub bonding material 522 of the second bonding material 52 faced to the first magnetic core 2 are coplanar with each other.

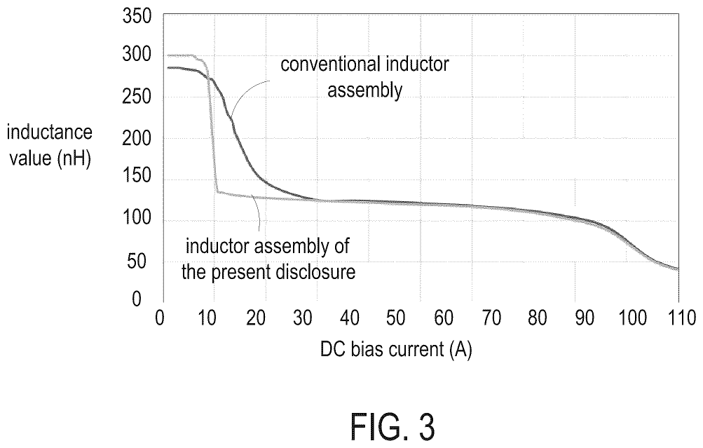

FIG. 3 is a schematic waveform diagram illustrating inductance value and DC bias current of the inductor assembly of the first embodiment of the present disclosure and the conventional inductor assembly. The inductance value and the DC bias current of the inductor assembly of the present disclosure and the conventional inductor assembly are measured when the environment temperature is 25 degrees. As shown in FIG. 3, when the DC bias current is ranged in the high-inductance region between 0 A to 10 A, the inductance value of the inductor assembly 1 of the present disclosure is 300 nH, and the inductance value of the conventional inductor assembly is 280 nH. Namely, the inductance value of the inductor assembly 1 of the present disclosure is greater than the inductance value of the conventional inductor assembly. Moreover, the interval of the DC bias current corresponding to the transition region of the inductor assembly 1 of the present disclosure is between 8 A to 10 A. The interval of the DC bias current corresponding to the transition region of the conventional inductor assembly is between 10 A to 25 A. Namely, the interval of the DC bias current corresponding to the transition region of the inductor assembly 1 of the present disclosure is less than the interval of the DC bias current corresponding to the transition region of the conventional inductor assembly.

From the above, the inductor assembly 1 of the present disclosure includes a bonding material layer 5 disposed between the first magnetic core 2 and the second magnetic core 3 and including a first bonding material 51 and a second bonding material 52. Namely, the inductor assembly 1 of the present disclosure utilizes the first bonding material 51 and the second bonding material 52 to fill the gap between the first magnetic core 2 and the second magnetic core 3 so as to increase the inductance value of the inductor assembly 1 ranged in the high-inductance region. Moreover, the magnetic permeability of the first bonding material 51 of the inductor assembly 1 of the present disclosure is greater than the magnetic permeability of the second bonding material 52. The first bonding material 51 with enhanced magnetic permeability can withstand a lower saturation current so that the magnetic permeability of the inductor assembly is decreased rapidly. Consequently, the interval of the DC bias current corresponding to the transition region of the inductor assembly 1 is reduced, and the response speed of the system utilizing the inductor assembly 1 is enhanced when the system is under heavy load.

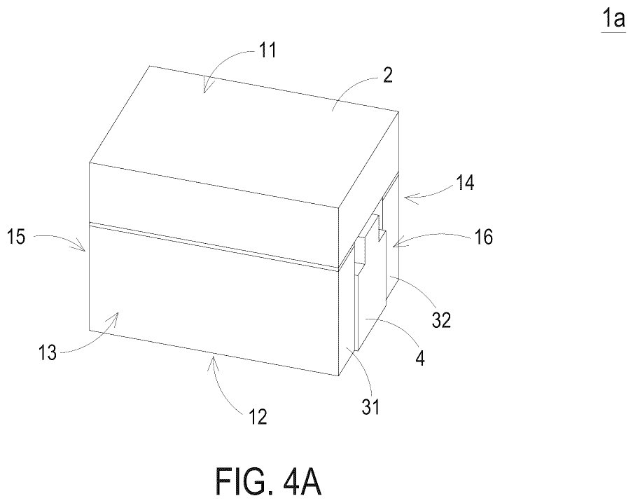

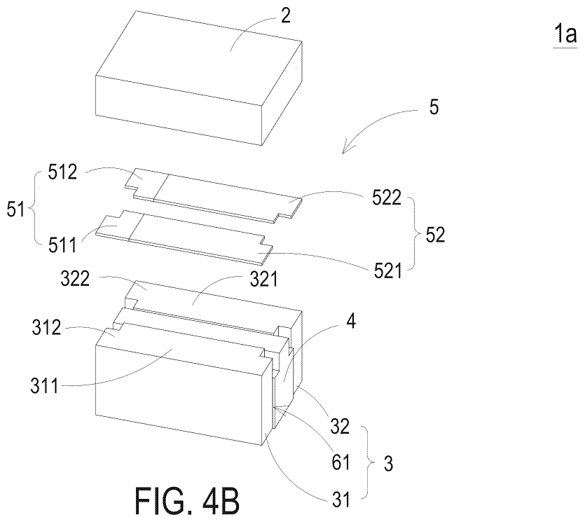

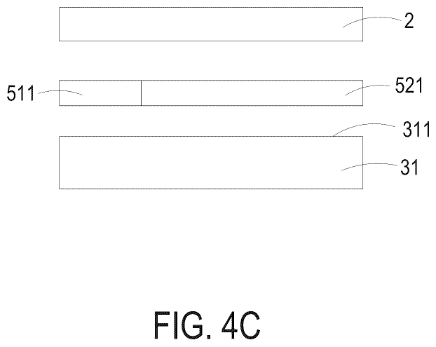

FIG. 4A is a schematic view illustrating an inductor assembly according to a second embodiment of the present disclosure. FIG. 4B is a schematic exploded view illustrating the inductor assembly of FIG. 4A. FIG. 4C is a schematic exploded lateral view illustrating the inductor assembly of FIG. 4A. The first sub magnetic core 31 and the second sub magnetic core 32 of the second magnetic core 3 of the inductor assembly 1 of the first embodiment have the elevated stage structure, respectively. Compared with the inductor assembly 1 of the first embodiment, the first sub magnetic core 31 and the second sub magnetic core 32 of the second magnetic core 3 of the inductor assembly 1a of this embodiment do not have the elevated stage structure, respectively. As shown in FIGS. 4A and 4B, in this embodiment, the surface of the first sub magnetic core 31 of the second magnetic core 3 of the inductor assembly 1a faced to the first magnetic core 2 only has the first platform 311. The surface of the second sub magnetic core 32 of the second magnetic core 3 of the inductor assembly 1a faced to the first magnetic core 2 only has the second platform 321.

In this embodiment, the third sub bonding material 521 and the first sub bonding material 511 are connected with each other in sequence, and disposed on the surface of the first platform 311 of the first sub magnetic core 31 of the second magnetic core 3. The fourth sub bonding material 522 and the second sub bonding material 512 are connected with each other in sequence, and disposed on the surface of the second platform 321 of the second sub magnetic core 32 of the second magnetic core 3. The position of the first sub bonding material 511 disposed on the first platform 311 of the first sub magnetic core 31 is corresponding to the position of the second sub bonding material 512 disposed on the second platform 321 of the second sub magnetic core 32, and the first sub bonding material 511 and the second sub bonding material 512 are separated by the first channel 61. The position of the third sub bonding material 521 disposed on the first platform 311 of the first sub magnetic core 31 is corresponding to the position of the fourth sub bonding material 522 disposed on the second platform 321 of the second sub magnetic core 32, and the third sub bonding material 521 and the fourth sub bonding material 522 are separated by the first channel 61. In this embodiment, the magnetic permeability of the first sub bonding material 511 is greater than twice of the magnetic permeability of the third sub bonding material 521. The magnetic permeability of the second sub bonding material 521 is greater than twice of the magnetic permeability of the fourth sub bonding material 522.

As shown in FIG. 4C, the first sub magnetic core 31 and the second sub magnetic core 32 of the second magnetic core 3 of the inductor assembly 1a of this embodiment only have single platform structure, respectively. Namely, the surface of the first sub magnetic core 31 of the second magnetic core 3 faced to the first magnetic core 2 does not have any height difference, and the surface of the second sub magnetic core 32 of the second magnetic core 3 faced to the first magnetic core 2 does not have any height difference. Consequently, the thickness of the first sub bonding material 511, the thickness of the second sub bonding material 512, the thickness of the third sub bonding material 521 and the thickness of the fourth sub bonding material 522 are identical.

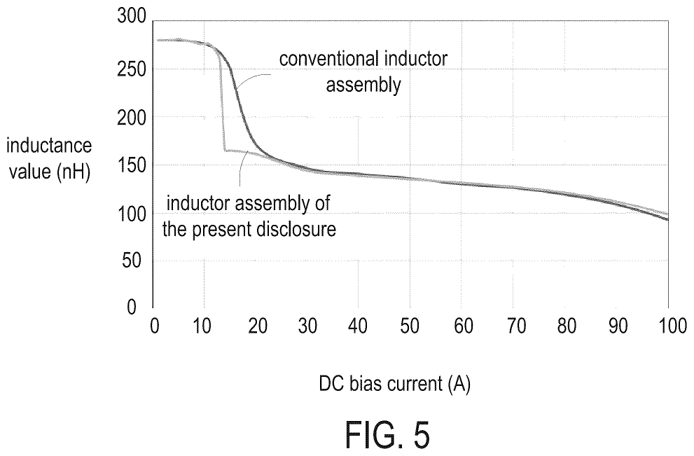

FIG. 5 is a schematic waveform diagram illustrating inductance value and DC bias current of the inductor assembly of the second embodiment of the present disclosure and the conventional inductor assembly. The inductance value and the DC bias current of the inductor assembly of the present disclosure and the conventional inductor assembly are measured when the environment temperature is 25 degrees. As shown in FIGS. 4A to 4C and 5, the interval of the DC bias current corresponding to the transition region of the inductor assembly 1a of the present disclosure is between 12 A to 13 A. The interval of the DC bias current corresponding to the transition region of the conventional inductor assembly is between 12 A to 22 A. Namely, the interval of the DC bias current corresponding to the transition region of the inductor assembly 1a of the present disclosure is less than the interval of the DC bias current corresponding to the transition region of the conventional inductor assembly. Consequently, the response speed of the system utilizing the inductor assembly 1a is enhanced when the system is under heavy load.

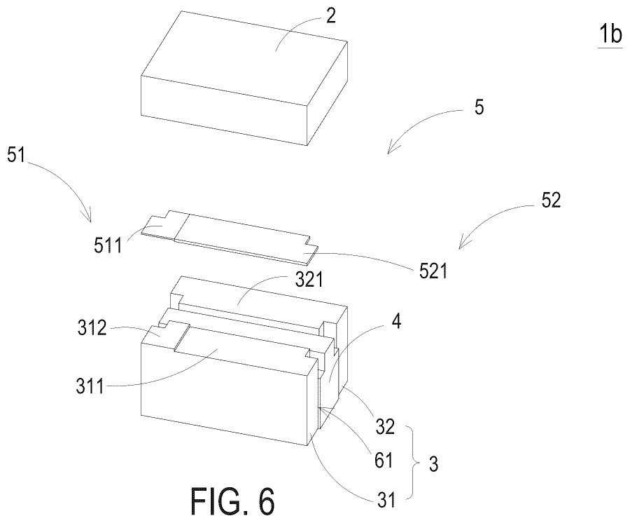

FIG. 6 is a schematic exploded view illustrating an inductor assembly according to a third embodiment of the present disclosure. The first bonding material 51 of the inductor assembly 1 of the first embodiment includes two sub bonding materials. Compared with the inductor assembly 1 of the first embodiment, the first bonding material 51 of the inductor assembly 1b of this embodiment only includes single sub bonding material, i.e., the first sub bonding material 511. The second bonding material 52 of the inductor assembly 1b of this embodiment only includes single sub bonding material, i.e., the third sub bonding material 521. The first sub bonding material 511 of the first bonding material 51 is disposed on the surface of the first elevated stage 312 of the first sub magnetic core 31 of the second magnetic core 3, and disposed between the first elevated stage 312 of the first sub magnetic core 31 of the second magnetic core 3 and the first magnetic core 2. The third sub bonding material 521 of the second bonding material 52 is disposed on the surface of the first platform 311 of the first sub magnetic core 31 of the second magnetic 3, and disposed between the first platform 311 of the first sub magnetic core 31 of the second magnetic 3 and the first magnetic core 2. In this embodiment, the surface of the second sub magnetic core 32 of the second magnetic core 3 faced to the first magnetic core 2 is directly or indirectly in contact with the lower surface of the first magnetic core 2.

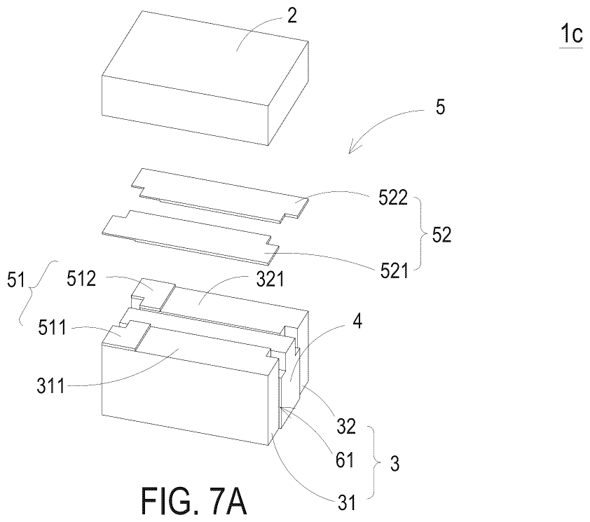

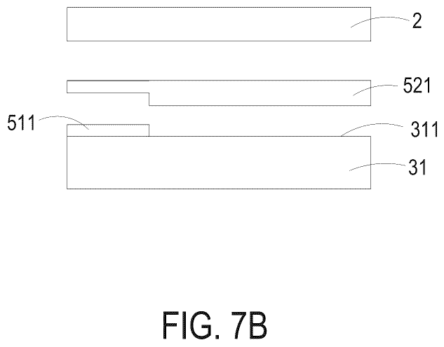

FIG. 7A is a schematic exploded view illustrating an inductor assembly according to a fourth embodiment of the present disclosure. FIG. 7B is a schematic exploded lateral view illustrating the inductor assembly of FIG. 7A. Compared with the inductor assembly 1 of the first embodiment, the surface of the first sub magnetic core 31 of the second magnetic core 3 of the inductor assembly 1c faced to the first magnetic core 2 only includes the first platform 311, and the surface of the second sub magnetic core 32 of the second magnetic core 3 of the inductor assembly 1c faced to the first magnetic core 2 only includes the second platform 321. In this embodiment, the first sub bonding material 511 of the first bonding material 51 of the inductor assembly 1c is disposed on the surface of the first platform 311 of the first sub magnetic core 31 of the second magnetic core 3. Namely, the lower surface of the first sub bonding material 511 of the first bonding material 51 is in contact with the surface of the first platform 311 of the first sub magnetic core 31 of the second magnetic core 3. The second sub bonding material 512 of the first bonding material 51 is disposed on the surface of the second platform 321 of the second sub magnetic core 32 of the second magnetic core 3. Namely, the lower surface of the second sub bonding material 512 of the first bonding material 51 is in contact with the surface of the second platform 321 of the second sub magnetic core 32 of the second magnetic core 3.

In this embodiment, portion of the third sub bonding material 521 of the second bonding material 52 of the inductor assembly 1c is disposed on the upper surface of the first sub bonding material 511 of the first bonding material 51, and the other portion of the third sub bonding material 521 of the second bonding material 52 of the inductor assembly 1c is disposed on the surface of the first platform 311 of the first sub magnetic core 31 of the second magnetic core 3. Namely, the lower surface of the third sub bonding material 521 of the second bonding material 52 is in contact with the upper surface of the first sub bonding material 511 of the first bonding material 51 and the surface of the first platform 311 of the first sub magnetic core 31 of the second magnetic core 3. Portion of the fourth sub bonding material 522 of the second bonding material 52 of the inductor assembly 1c is disposed on the upper surface of the second sub bonding material 512 of the first bonding material 51, and the other portion of the fourth sub bonding material 522 of the second bonding material 52 of the inductor assembly 1c is disposed on the surface of the second platform 321 of the second sub magnetic core 32 of the second magnetic core 3. Namely, the lower surface of the fourth sub bonding material 522 of the second bonding material 52 is in contact with the upper surface of the second sub bonding material 512 of the first bonding material 51 and the surface of the second platform 321 of the second sub magnetic core 32 of the second magnetic core 3.

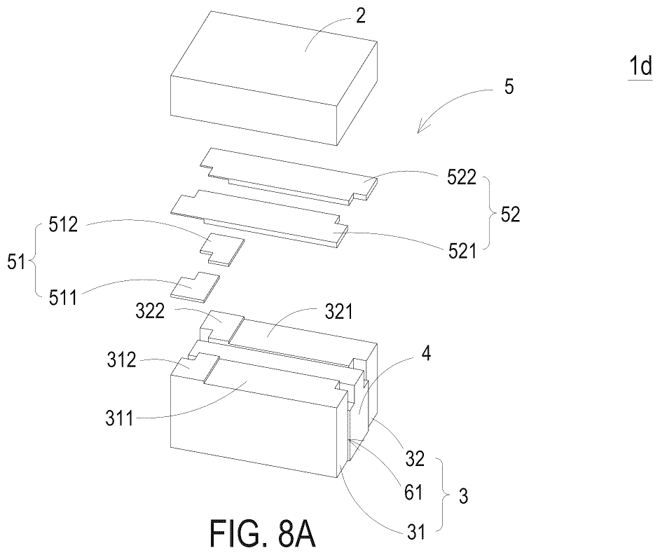

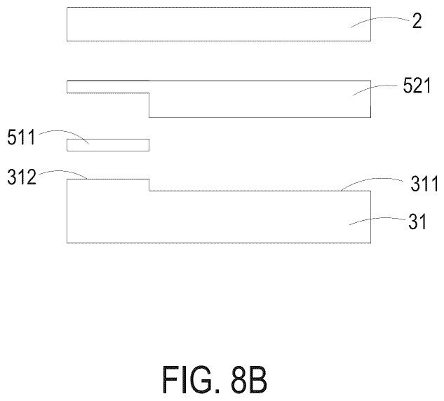

FIG. 8A is a schematic exploded view illustrating an inductor assembly according to a fifth embodiment of the present disclosure. FIG. 8B is a schematic exploded lateral view illustrating the inductor assembly of FIG. 8A. Compared with the inductor assembly 1 of the first embodiment, the first sub bonding material 511 of the first bonding material 51 of the inductor assembly 1d of this embodiment is disposed on the surface of the first elevated stage 312 of the first sub magnetic core 31 of the second magnetic core 3. Namely, the lower surface of the first sub bonding material 511 of the first bonding material 51 is in contact with the surface of the first elevated stage 312 of the first sub magnetic core 31 of the second magnetic core 3. The second sub bonding material 512 of the first bonding material 51 of the inductor assembly 1d of this embodiment is disposed on the surface of the second elevated stage 322 of the second sub magnetic core 32 of the second magnetic core 3. Namely, the lower surface of the second sub bonding material 512 of the first bonding material 51 is in contact with the surface of the second elevated stage 322 of the second sub magnetic core 32 of the second magnetic core 3.

In this embodiment, portion of the third sub binding material 521 of the second bonding material 52 of the inductor assembly 1d is disposed on the upper surface of the first sub bonding material 511 of the first bonding material 51, and the other portion of the third sub binding material 521 of the second bonding material 52 of the inductor assembly 1d is disposed on the surface of the first platform 311 of the first sub magnetic core 31 of the second magnetic core 3. Namely, the lower surface of the third sub bonding material 521 of the second bonding material 52 is in contact with the upper surface of the first sub binding material 511 of the first bonding material 51 and the surface of the first platform 311 of the first sub magnetic core 31 of the second magnetic core 3. Portion of the fourth sub binding material 522 of the second bonding material 52 of the inductor assembly 1d is disposed on the upper surface of the second sub bonding material 512 of the first bonding material 51, and the other portion of the fourth sub binding material 522 of the second bonding material 52 of the inductor assembly 1d is disposed on the surface of the second platform 321 of the second sub magnetic core 32 of the second magnetic core 3. Namely, the lower surface of the fourth sub bonding material 522 of the second bonding material 52 is in contact with the upper surface of the second sub binding material 512 of the first bonding material 51 and the surface of the second platform 321 of the second sub magnetic core 32 of the second magnetic core 3.

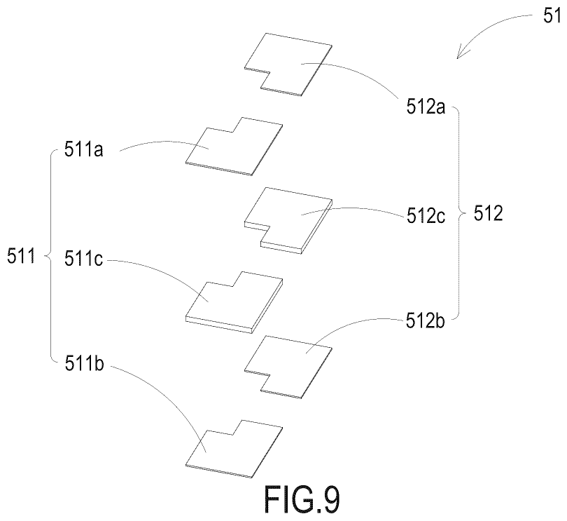

FIG. 9 is a detailed schematic exploded view illustrating a first bonding material of the inductor assembly of the present disclosure. As shown in FIGS. 2A to 2C and 9, the first sub bonding material 511 of the first bonding material 51 of the inductor assembly 1 of the present disclosure includes an upper cover layer 511a, a lower cover layer 511b and a high magnetic permeability layer 511c. The upper cover layer 511a, the high magnetic permeability layer 511c and the lower cover layer 511b are arranged between the first magnetic core 2 and the second magnetic core 3 in sequence. The magnetic permeability of the high magnetic permeability layer 511c is greater than the magnetic permeability of the upper cover layer 511a and the magnetic permeability of the lower cover layer 511b. The second sub bonding material 512 of the first bonding material 51 includes an upper cover layer 512a, a lower cover layer 512b and a high magnetic permeability layer 512c. The upper cover layer 512a, the high magnetic permeability layer 512c and the lower cover layer 512b are arranged between the first magnetic core 2 and the second magnetic core 3 in sequence. The magnetic permeability of the high magnetic permeability layer 512c is greater than the magnetic permeability of the upper cover layer 512a and the magnetic permeability of the lower cover layer 512b.

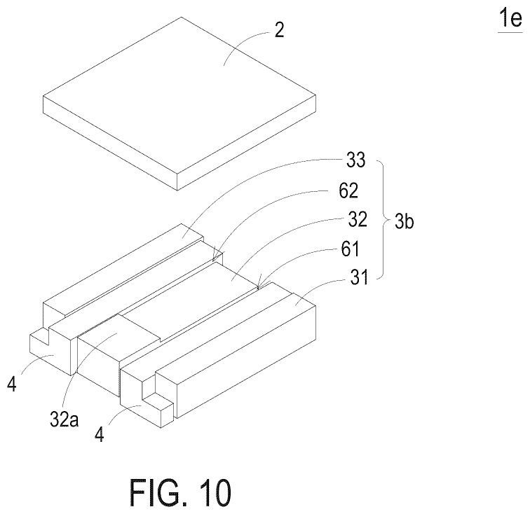

In some embodiments, the number and the position of the second magnetic core can be adjusted according to the practical requirements. FIG. 10 is a partial schematic exploded view illustrating an inductor assembly according to a sixth embodiment of the present disclosure. As shown in FIG. 10, the first magnetic core 2, the second magnetic core 3b and the winding 4 of the inductor assembly 1e are shown, but the bonding material is omitted. In this embodiment, the second magnetic core 3b of the inductor assembly 1e includes three sub magnetic cores and two channels, i.e., a first sub magnetic core 31, a second sub magnetic core 32, a third sub magnetic core 33, a first channel 61 and a second channel 62. The first sub magnetic core 31, the second sub magnetic core 32 and the third sub magnetic core 33 are arranged in parallel. The first channel 61 is disposed between the first sub magnetic core 31 and the second sub magnetic core 32. The second channel 62 is disposed between the second sub magnetic core 32 and the third sub magnetic core 33. In this embodiment, the second sub magnetic core 32 includes an elevated stage 32a adjacent to the fifth surface 15 of the inductor assembly 1e. Portion of the winding 4 is disposed within the first channel 61, and the other portion of the winding 4 is disposed within the second channel 62. In this embodiment, the position of the surface of the inductor assembly 1e is similar to the position of the surface of the inductor assembly 1.

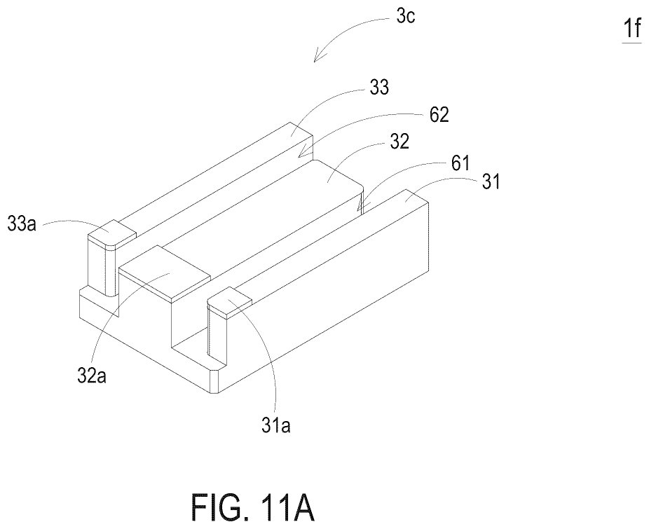

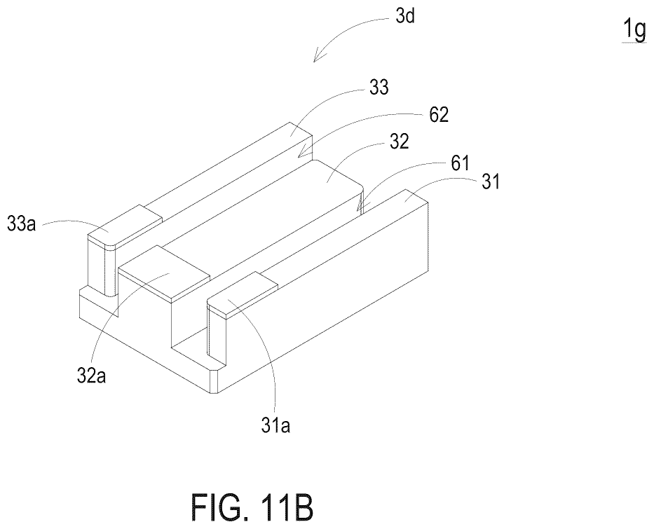

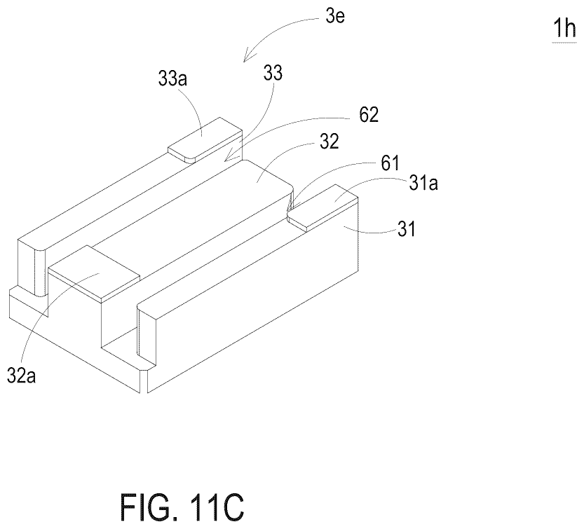

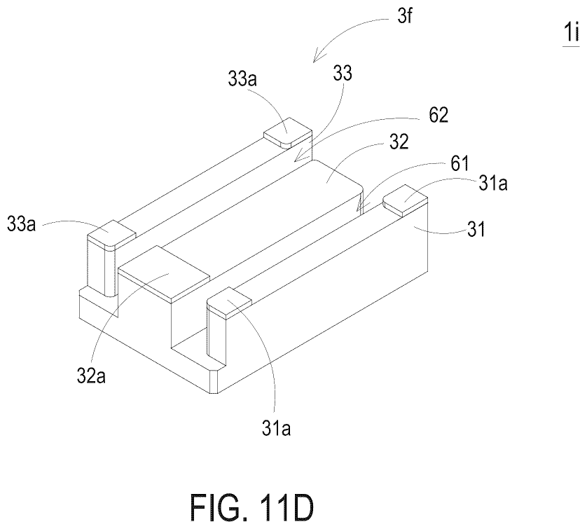

Certainly, the position, the number and the arrangement area of the elevated stage can be adjusted. FIG. 11A is a schematic view illustrating a second magnetic core of an inductor assembly according to a seventh embodiment of the present disclosure. In this embodiment, the first sub magnetic core 31 of the second magnetic core 3c of the inductor assembly 1f includes an elevated stage 31a adjacent to the fifth surface 15 of the inductor assembly 1f. The second sub magnetic core 32 includes an elevated stage 32a adjacent to the fifth surface 15 of the inductor assembly 1f. The third sub magnetic core 33 includes an elevated stage 33a adjacent to the fifth surface 15 of the inductor assembly 1f. The arrangement area of the elevated stage 32a of the second sub magnetic core 32 is greater than the arrangement area of the elevated stage 31a of the first sub magnetic core 31 and the arrangement area of the elevated stage 33a of the third sub magnetic core 33. The length of the elevated stage 32a of the second sub magnetic core 32 in the direction from the fifth surface 15 toward the sixth surface 16 is greater than the length of the elevated stage 31a of the first sub magnetic core 31 in the direction from the fifth surface 15 toward the sixth surface 16 and the length of the elevated stage 33a of the third sub magnetic core 33 in the direction from the fifth surface 15 toward the sixth surface 16.

In some embodiments, as shown in FIG. 11B, the length of the elevated stage 31a of the first sub magnetic core 31 in the direction from the fifth surface 15 toward the sixth surface 16 is greater than the length of the elevated stage 32a of the second sub magnetic core 32 in the direction from the fifth surface 15 toward the sixth surface 16, and the length of the elevated stage 33a of the third sub magnetic core 33 in the direction from the fifth surface 15 toward the sixth surface 16 is greater than the length of the elevated stage 32a of the second sub magnetic core 32 in the direction from the fifth surface 15 toward the sixth surface 16.

In some embodiments, as shown in FIG. 11C, the elevated stage 31a of the first sub magnetic core 31 is adjacent to the sixth surface 16 of the inductor assembly 1h. The elevated stage 32a of the second sub magnetic core 32 is adjacent to the fifth surface 15 of the inductor assembly 1h. The elevated stage 33a of the third sub magnetic core 33 is adjacent to the sixth surface 16 of the inductor assembly 1h.

In some embodiments, as shown in FIG. 11D, the first sub magnetic core 31 includes two elevated stages 31a adjacent to the fifth surface 15 and the sixth surface 16 of the inductor assembly 1i, respectively. The second sub magnetic core 32 includes an elevated stage 32a adjacent to the fifth surface 15 of the inductor assembly 1i. The third sub magnetic core 33 includes two elevated stages 33a adjacent to the fifth surface 15 and the sixth surface 16 of the inductor assembly 1i, respectively.

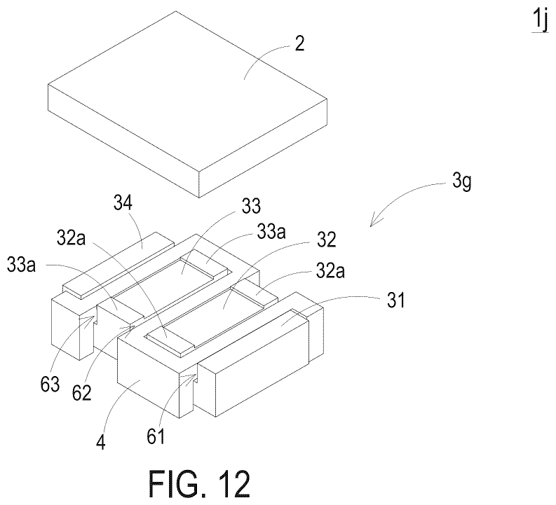

FIG. 12 is a partial schematic exploded view illustrating an inductor assembly according to an eleventh embodiment of the present disclosure. As shown in FIG. 12, the first magnetic core 2, the second magnetic core 3g and the winding 4 of the inductor assembly 1j are shown, but the bonding material is omitted. In this embodiment, the second magnetic core 3g of the inductor assembly 1j includes four sub magnetic cores and three channels, i.e., a first sub magnetic core 31, a second sub magnetic core 32, a third sub magnetic core 33, a fourth sub magnetic core 34, a first channel 61, a second channel 62 and a third channel 63. The first sub magnetic core 31, the second sub magnetic core 32, the third sub magnetic core 33 and the fourth sub magnetic core 34 are arranged in parallel. The first channel 61 is disposed between the first sub magnetic core 31 and the second sub magnetic core 32. The second channel 62 is disposed between the second sub magnetic core 32 and the third sub magnetic core 33. The third channel 63 is disposed between the third sub magnetic core 33 and the fourth magnetic core 34. The second sub magnetic core 32 includes two elevated stages 32a adjacent to the fifth surface 15 and the sixth surface 16 of the inductor assembly 1j, respectively. The third sub magnetic core 33 includes two elevated stages 32a adjacent to the fifth surface 15 and the sixth surface 16 of the inductor assembly 1j, respectively. Certainly, the arrangement and position of the elevated stage 32a and the elevated stage 33a can be adjusted. Portion of the winding 4 is disposed within the first channel 61, portion of the winding 4 is disposed within the second channel 62, and the other portion of the winding 4 is disposed within the third channel 63. The winding 4 disposed within the first channel 61 and the winding 4 disposed within the second channel 62 are connected with each other adjacent to the fifth surface 15 of the inductor assembly 1j. The winding 4 disposed within the second channel 62 and the winding 4 disposed within the third channel 63 are connected with each other adjacent to the sixth surface 16 of the inductor assembly 1j.

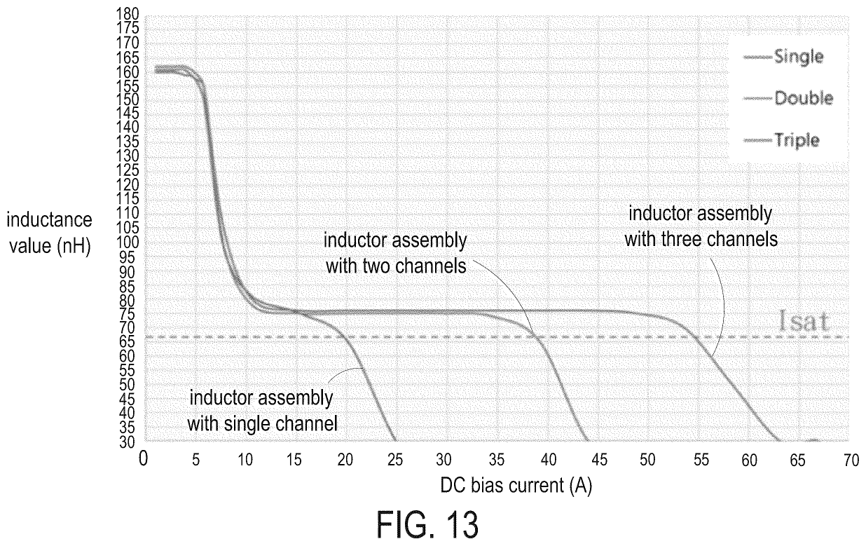

FIG. 13 is a schematic waveform diagram illustrating inductance value and DC bias current of the inductor assembly of the first embodiment, the sixth embodiment and the eleventh embodiment of the present disclosure. The second magnetic core 3 of the inductor assembly 1 of the first embodiment includes single channel. The second magnetic core 3b of the inductor assembly 1e of the sixth embodiment includes two channels. The second magnetic core 3g of the inductor assembly 1j of the eleventh embodiment includes three channels. The saturation currents of the inductor assemblies of the first embodiment, the sixth embodiment and the eleventh embodiment of the present disclosure are shown in FIG. 13. In case that the inductance value is 65 nH, the saturation current of the inductor assembly 1 of the first embodiment of FIGS. 2A to 2C including single channel is 20 A, the saturation current of the inductor assembly 1e of the sixth embodiment of FIG. 10 including two channels is 39 A, and saturation current of the inductor assembly 1j of the eleventh embodiment of FIG. 12 including three channels is 55 A. Consequently, the numbers of the sub magnetic core and the channel can be adjusted according to the practical requirements so as to achieve the corresponding saturation current.

As mentioned above, the inductor assembly of the present disclosure includes a bonding material layer disposed between the first magnetic core and the second magnetic core and including a first bonding material and a second bonding material. Namely, the inductor assembly of the present disclosure utilizes the first bonding material and the second bonding material to fill the gap between the first magnetic core and the second magnetic core so as to increase the inductance value of the inductor assembly ranged in the high-inductance region. Moreover, the magnetic permeability of the first bonding material of the inductor assembly of the present disclosure is greater than the magnetic permeability of the second bonding material, or the thickness of the first bonding material is less than the thickness of the second bonding material. The first bonding material with enhanced magnetic permeability (or reduced thickness) can withstand a lower saturation current so that the magnetic permeability is decreased rapidly. Consequently, the interval of the DC bias current corresponding to the transition region of the inductor assembly is reduced, and the response speed of the system utilizing the inductor assembly is enhanced when the system is under heavy load.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An inductor assembly, comprising:
a first magnetic core;
a second magnetic core comprising a channel;
a winding disposed within the channel; and
a bonding material layer disposed between the first magnetic core and the second magnetic core and comprising a first bonding material and a second bonding material, wherein a magnetic permeability of the first bonding material is greater than a magnetic permeability of the second bonding material, wherein the first bonding material and the second bonding material are disposed on the second magnetic core, and a surface of the first bonding material faced to the first magnetic core and a surface of the second bonding material faced to the first magnetic core are coplanar with each other.

2. The inductor assembly according to claim 1, wherein the second magnetic core comprises a first sub magnetic core and a second sub magnetic core, the channel is disposed between the first sub magnetic core and the second sub magnetic core, a surface of the first sub magnetic core faced to the first magnetic core comprises a first platform and a first elevated stage, and the first elevated stage is closer to the first magnetic core than the first platform.

3. The inductor assembly according to claim 2, wherein a surface of the second sub magnetic core faced to the first magnetic core comprises a second platform and a second elevated stage, and the second elevated stage is closer to the first magnetic core than the second platform.

4. The inductor assembly according to claim 3, wherein the first bonding material is disposed on a surface of the first elevated stage and a surface of the second elevated stage, and the second bonding material is disposed on a surface of the first platform and a surface of the second platform.

5. The inductor assembly according to claim 2, wherein the first bonding material is disposed on a surface of the first elevated stage, and the second bonding material is disposed on a surface of the first platform.

6. The inductor assembly according to claim 1, wherein a thickness of the first bonding material is less than a thickness of the second bonding material.

7. The inductor assembly according to claim 1, wherein the first bonding material comprises an upper cover layer, a lower cover layer and a high magnetic permeability layer, wherein the upper cover layer, the high magnetic permeability layer and the lower cover layer are arranged between the first magnetic core and the second magnetic core in sequence, and a magnetic permeability of the high magnetic permeability layer is greater than a magnetic permeability of the upper cover layer and a magnetic permeability of the lower cover layer.

8. An inductor assembly, comprising:
a first magnetic core;
a second magnetic core;
a winding; and
a bonding material layer disposed between the first magnetic core and the second magnetic core and comprising a first bonding material and a second bonding material, wherein a thickness of the first bonding material is less than a thickness of the second bonding material, and a surface of the first bonding material faced to the first magnetic core and a surface of the second bonding material faced to the first magnetic core are coplanar with each other.

9. The inductor assembly according to claim 8, wherein the second magnetic core comprises a first sub magnetic core and a second sub magnetic core, the channel is disposed between the first sub magnetic core and the second sub magnetic core, a surface of the first sub magnetic core faced to the first magnetic core comprises a first platform and a first elevated stage, and the first elevated stage is closer to the first magnetic core than the first platform.

10. The inductor assembly according to claim 9, wherein a surface of the second sub magnetic core faced to the first magnetic core comprises a second platform and a second elevated stage, and the second elevated stage is closer to the first magnetic core than the second platform.

11. The inductor assembly according to claim 10, wherein the first bonding material is disposed on a surface of the first elevated stage and a surface of the second elevated stage, and the second bonding material is disposed on a surface of the first platform and a surface of the second platform.

12. The inductor assembly according to claim 9, wherein the first bonding material is disposed on a surface of the first elevated stage, and the second bonding material is disposed on a surface of the first platform.

13. The inductor assembly according to claim 8, wherein the first bonding material comprises an upper cover layer, a lower cover layer and a high magnetic permeability layer, wherein the upper cover layer, the high magnetic permeability layer and the lower cover layer are arranged between the first magnetic core and the second magnetic core in sequence, and a magnetic permeability of the high magnetic permeability layer is greater than a magnetic permeability of the upper cover layer and a magnetic permeability of the lower cover layer.

14. An inductor assembly, comprising:
a first magnetic core;
a second magnetic core;
a winding disposed between the first magnetic core and the second magnetic core;
a first bonding material, wherein a lower surface of the first bonding material is in contact with the second magnetic core; and
a second bonding material, wherein a lower surface of the second bonding material is in contact with an upper surface of the first bonding material and the second magnetic core, and an upper surface of the second bonding material is in contact with the first magnetic core.

15. The inductor assembly according to claim 14, wherein a surface of the second magnetic core faced to the first magnetic core comprises a first elevated stage.

16. The inductor assembly according to claim 15, wherein the first binding material is disposed on a surface of the first elevated stage.

17. The inductor assembly according to claim 14, wherein a magnetic permeability of the first bonding material is greater than a magnetic permeability of the second bonding material.

18. The inductor assembly according to claim 14, wherein the first bonding material comprises an upper cover layer, a lower cover layer and a high magnetic permeability layer, wherein the upper cover layer, the high magnetic permeability layer and the lower cover layer are arranged between the first magnetic core and the second magnetic core in sequence, and a magnetic permeability of the high magnetic permeability layer is greater than a magnetic permeability of the upper cover layer and a magnetic permeability of the lower cover layer.
